(19) United States
(12) Patent Application Publication
(10) Pub. No.: US 2014/0330585 A1
(43) Pub. Date: Nov. 6, 2014

(54) Health Care Communications Management System And Method Of Use

(71) Applicant: Simple Medical Software Inc., San Antonio, TX (US)

(72) Inventors: Manuel Martinez, San Antonio, TX (US); Jose Luis Bravo Garcia, San Antonio, TX (US); Ricardo Andres Garrett, San Antonio, TX (US); Cristian Alexandru Partica, San Antonio, TX (US); Ruben Gamez Zamorano, San Antonio, TX (US)

(73) Assignee: Simple Medical Software Inc., San Antonio, TX (US)

(21) Appl. No.: 14/265,876

(22) Filed: Apr. 30, 2014

Related U.S. Application Data
(60) Provisional application No. 61/818,402, filed on May 1, 2013.

(51) Int. Cl. G06F 19/00

(52) U.S. Cl. CPC G06F 19/322
USPC 705/3

(57) ABSTRACT

A system and method of use directed to a health care system is disclosed herein. More specifically, a system and method of use for managing the communications between health care providers and managing the patient's data before, during, and after receiving medical care is disclosed herein. In one embodiment, the system is comprised of automatic patient data sharing in communications between health care providers and support staff. In another embodiment, the system is comprised of automatic group messaging. In yet another embodiment, the system is comprised of automatic sharing of pending items and alerts. In another embodiment, the system is comprised of post medical care communications between the patient and health care providers.

### CROSS-REFERENCE TO RELATED APPLICATIONS

This application claims the benefit under Title 35 U.S. Code §119(e) of U.S. Provisional Patent Application Ser. No. 61/818,402; Filed: May 1, 2013, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to a system and method of use directed to a health care system. More specifically, the present invention relates to a system and method of use for managing the communications between health care providers and managing the patient's data before, during, and after receiving medical care.

### BACKGROUND OF THE INVENTION

Without limiting the scope of the disclosed system and method, the background is described in connection with a novel system and approach directed to managing communications between health care providers and managing the patient's data.

In health care environments, patients are often in contact with several health care professionals/providers during their visit. There is the check-in support staff, nurses, physicians, and billing staff to name just a few of the interactions the patient will have. In surgical environments, you may have a team of physicians working with the patient such as an anesthesiologist and surgeons. With multiple interactions, there can be several data entry points creating disparate data repositories. With disparate data repositories comes duplication of efforts with redundant data entry creating the potential for error. In addition, the extraction of data can have multiple sources to pull from which may or may not be in sync. Each health care professional may be pulling data on the patient from various and different sources than the other health care professionals on the team. Adding to the complexity, current systems to facilitate and coordinate the communications among providers are difficult to use, expensive, and/ or fragmented. Charts and disparate systems are currently the norm today for maintaining the process flow of information between the health care providers.

Once the patient is discharged, depending on the health care provider's setup, communication with the team that cared for the patient in the hospital is difficult for both the patient and the outpatient physicians, leading to an increase in hospital readmissions. There currently is no mechanism or process in place that is simple, effective, and efficient.

A first example of a health care system in the prior art is described in U.S. Pat. No. 8,340,792 issued on Dec. 25, 2012 to Joseph Condurso et al. In this example, the system utilizes one or more databases and includes guidelines and protocols representing best medical practices and is directed to managing therapy and medication delivery.

A second example of a health care system in the prior art is described in U.S. Pat. No. 8,352,289 issued on Jan. 8, 2013 to Dale E. Sandberg et al. In this example, the system is directed to a customizable electronic patient form.

While all of the aforementioned approaches may fulfill their unique purposes, none of them fulfill the need for a practical and effective means for providing communications management between health care providers in conjunction with managing the patient's data along with follow-up functionality in allowing the patient access to their health care provider post medical care.

The present invention therefore proposes a novel system and method of use for managing the communications between health care providers and managing the patient's data before, during, and after receiving medical care.

### BRIEF SUMMARY OF THE INVENTION

The present invention, therefore, provides a system and method of use for managing the communications between health care providers and managing the patient's data before, during, and after receiving medical care.

In one embodiment, the system is comprised of automatic patient data sharing in communications between health care providers and support staff. That is, based on the communication type and the user types, certain patient data will also be shared along with the communication being made between the users. In another embodiment, the system is comprised of automatic group messaging. This function allows an individual providing care to automatically create a communication group having as members all those administering care to a particular patient. This allows a quick and easy way to ensure a communication is received by all those responsible for the care of an individual. In yet another embodiment, the system is comprised of automatic sharing of pending items and alerts. This component allows the crosschecking and validation of procedures and pending items scheduled for a patient. For example, if blood work is pending, all others involved in the care of a patient will be able to visually see this work as a pending item to be performed and thus preventing redundant work. In another embodiment, the system is comprised of post medical care communications between the patient and health care providers. This allows the patient user to quickly reach and communicate with their health care provider post onsite medical care.

In summary, the present invention generally relates to a system and method of use directed to a health care system. More specifically, the present invention relates to a system and method of use for managing the communications between health care providers and managing the patient's data before, during, and after receiving medical care.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a system architecture diagram of the health care communications management system in accordance with embodiments of the disclosure;

FIG. 2 is a layout of the software modules for the client I/O device for the health care communications management system in accordance with embodiments of the disclosure;

FIG. 3 is a main screen of the graphical user interface for the client I/O devices for the health care communications management system in accordance with embodiments of the disclosure;

FIG. 4 is a secure text screen of the graphical user interface for the client I/O devices for the health care communications management system in accordance with embodiments of the disclosure;

FIG. 5 is a census screen of the graphical user interface for the client I/O devices for the health care communications management system in accordance with embodiments of the disclosure;

FIG. 6 is an initial patient selection screen for the graphical user interface for the client I/O devices for the health care communications management system in accordance with embodiments of the disclosure;

FIG. 7 is a patient information screen for the graphical user interface for the client I/O devices for the health care communications management system in accordance with embodiments of the disclosure;

FIG. 8 is an additional patient information screen for the graphical user interface for the client I/O devices for the health care communications management system in accordance with embodiments of the disclosure;

FIG. 9 is an initial sign out screen for the graphical user interface for the client I/O devices for the health care communications management system in accordance with embodiments of the disclosure;

FIG. 10 is a coverage screen for the graphical user interface for the client I/O devices for the health care communications management system in accordance with embodiments of the disclosure;

FIG. 11 is a sign out coverage screen summary for the graphical user interface for the client I/O devices for the health care communications management system in accordance with embodiments of the disclosure;

FIG. 12 is a billing screen of the graphical user interface for the client I/O devices for the health care communications management system in accordance with embodiments of the disclosure;

FIG. 13 is a work flow diagram of automatic data sharing functionality within the health care communications management system in accordance with embodiments of the disclosure;

FIG. 14 is a work flow diagram of the automatic group messaging functionality within the health care communications management system in accordance with embodiments of the disclosure;

FIG. 15 is a work flow diagram of the automatic sharing of pending items and alerts within the health care communications management system in accordance with embodiments of the disclosure;

FIG. 16 is a work flow diagram of the post medical care communications between patients and health care providers within the health care communications management system in accordance with embodiments of the disclosure.

FIG. 17 is the first half of a work flow diagram of an ER patient admission example for the health care communications management system in accordance with embodiments of the disclosure;

FIG. 18 is the second half of a work flow diagram of an ER patient admission example for the health care communications management system in accordance with embodiments of the disclosure.

### DETAILED DESCRIPTION OF THE INVENTION

Disclosed herein is an improved system and method of use for managing the communications between health care providers and managing the patient's data before, during, and after receiving medical care. The numerous innovative teachings of the present invention will be described with particular reference to several embodiments (by way of example, and not of limitation).

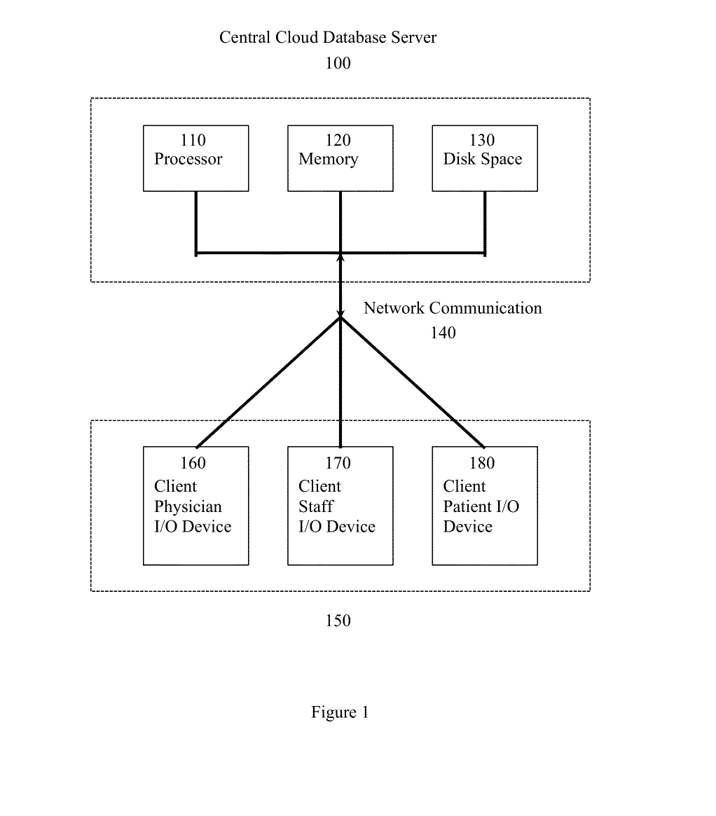

Reference is first made to FIG. 1, a system architecture diagram of the health care communications management system in accordance with embodiments of the disclosure. In one embodiment, the system and method of use for managing the communications between health care providers and managing the patient's data before, during, and after receiving medical care is comprised of a central database server 100, a network 140, and client input/output (I/O) graphical user interfaces (GUI) or devices 150.

The central database server 100 is comprised of the essential components needed for data storage and management such as but not limited to a processor 110, transitory computer readable storage medium 120, and non transitory computer readable storage medium 130. Software or machine instructions also reside on the central database server 100 for processing and serving the data. Patient data within the system is structured into several levels or layers with communication granted privileges. That is the system predetermines the layer of security and privileges for each type of communication and user type and restricts or allows the sharing of information accordingly.

In one embodiment, the system is structured into six levels. Level one data is permanent data that does not change with time such as the patients name, date of birth, and sex. Level two data is information that may change, but is independent of time, encounter type, or medical care. Level two data examples include patient address, phone number, and insurance information. Level three data is information that is generated during medical care and will generate medical history on the patient. Level three data examples include diagnosis, physicians, admissions information, and attachments. Level four data is information that is unique to a medical care instance and includes for example, the medical facility's name and the patient's bed number. Level five data includes information that is also unique to a medical care instance but is dynamic during the medical care and includes information such as pending tasks/reminders, active physician list, and diagnosis. The last level, level six, is the most dynamic level of information and the one that determines how all of the other levels are shared or not shared with communication and group granted privileges. As previously stated, the user type and/or type of communication determines the information that is shared. Examples of level 6 data includes secure communications, sign out message, billing communications, and group communications.

In one embodiment the user types are physician, staff, and patient. User types may be added, deleted, and/or changed and can be configured to each health care environment to be supported by the system. In one embodiment, the communication types are physician to physician communications, physician and staff communications, and physician and patient communications. These communication types can also be added, deleted, and/or changed and can be configured to each health care environment to be supported by the system.

Data access or sharing may also be partitioned or restricted based on user groups as well. For example, physicians associated with a network or group would only be able to see those patients within their respective networks or groups. This allows the system to maintain several user groups or clients within one physical system without having to partition the system at the physical hardware level.

In yet another embodiment, for those patients that are temporarily seeing a physician which utilizes the system and their primary physician does not use the system, the system also comprises a means of data importing and exporting the patient's information. For example, a two-way data connection can be made with the primary physician's system for the sharing of information or as another example, a data export of the patient's information can be sent via email on triggering actions such as a procedure being completed.

The system utilizes a network 140 for communicating between components which may be wired or wireless. The client I/O interfaces 150 may be any interface which allows the user to interact with the system. The user interface may be customized for physicians 160, support staff 170, or patients 180. These I/O interfaces 150 may be a workstation, laptop, mobile device, or any device allowing a user to interact with the system. The I/O device 150 may also be comprised of a local copy of the data which can be accessed by the user in case of a network communications failure. Should a network communications failure occur, the I/O device 150 may be configured to operate and function on the local data copy until network communications are restored and then a data sync up will occur restoring the data integrity of the system.

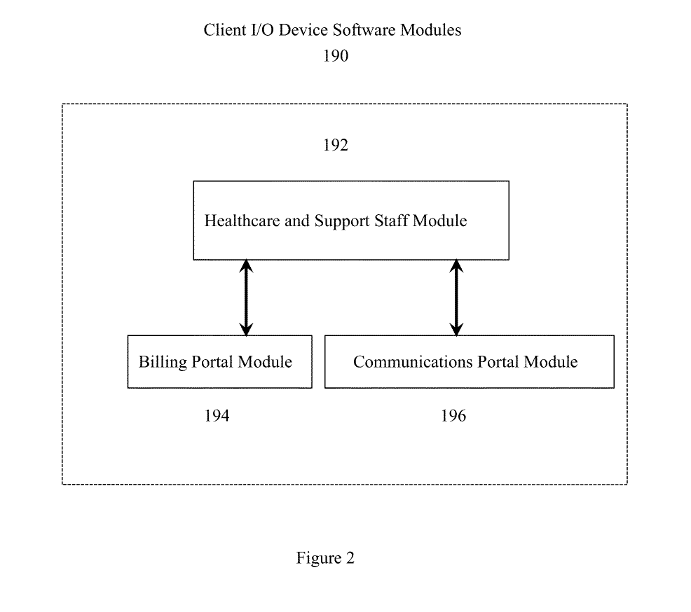

Reference is next made to FIG. 2, a layout of the software modules 190 for the client I/O devices 150 for the health care communications management system in accordance with embodiments of the disclosure. Shown in this illustration are three primary software modules or graphical user interfaces 190, which reside on the client I/O devices 150. These modules may reside on independent devices or together with other modules. The healthcare and support staff module 192 is the primary module utilized by healthcare providers and support staff. This module will be detailed more thoroughly in the following paragraphs. The billing portal module 194 is used by coders and/or billing staff and is integrated with the healthcare and support staff module 192. The modules are integrated by allowing them to share and communicate information between them. For example, coders are able to physician and patient billings data. If there is an issue or question about a billing code, the coder can interact with the physician through the billing portal to address matters. Likewise, the communications portal module 196 is used by support staff and allows them to communicate with healthcare providers. These modules are also integrated by allowing them to share and communicate information between them.

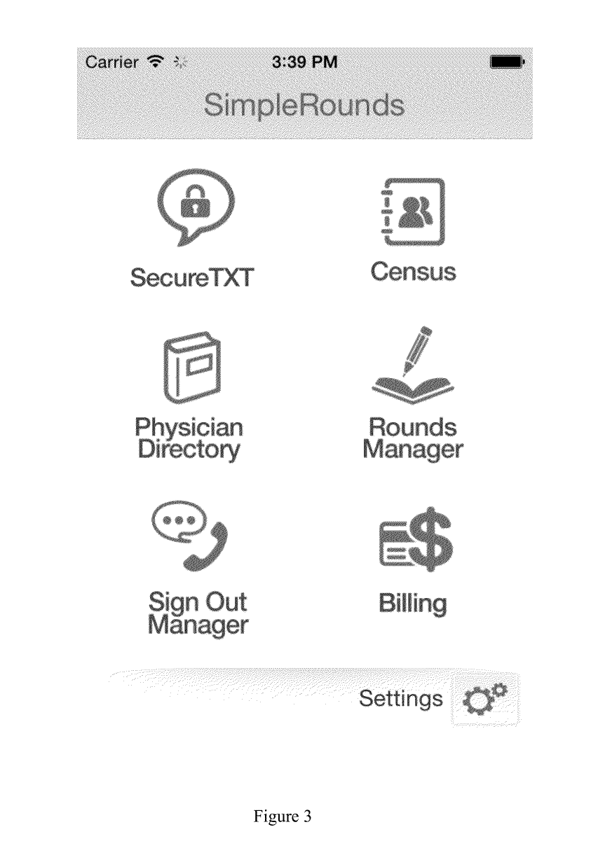

Reference is now made to FIG. 3, a main screen of the graphical user interface 192 for the client I/O devices 150 for the health care communications management system in accordance with embodiments of the disclosure. Shown in this illustration is the main screen to the Healthcare and Support Staff Module 192 called “SimpleRounds” which allows access to the six main areas of the interface: Secure TXT, Census, Physician Directory, Rounds Manager, Sign Out Manager, and Billing. Also shown is the settings icon, which allows customizations for the user such as password setting and alerts for special texting. The Physician Directory is a listing of all physicians setup for a group and provides contact and specialty information.

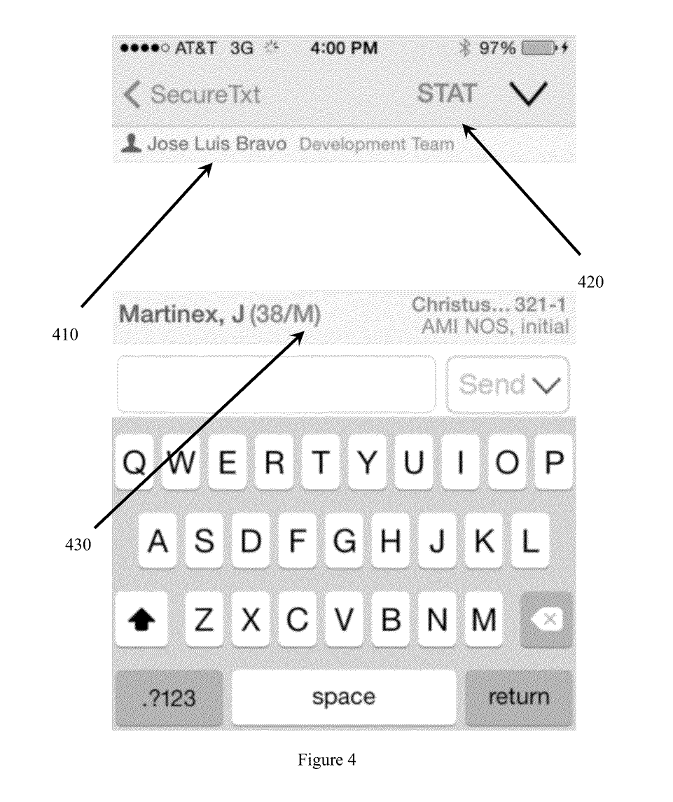

Reference is next made to FIG. 4, a secure text screen of the graphical user interface for the client I/O devices 150 for the health care communications management system in accordance with embodiments of the disclosure. Once the user selects “SecureTXT”, they can select the group or physicians they want to send a text or communications to. Next, the user can select the patient associated with the text or communication. As seen in this illustration, the name of the individual the text is being sent to is displayed 410. In addition, shared patient information such as name, age, sex, hospital, room, and status is automatically populated as part of the shared or non shared communication or text 430. The term shared communication refers to communications involving more than one receiver of the communication. The term shared data communication refers to communications where patient data is shared. The interface 192 also allows the attaching of images and files. If the “STAT” icon 420 is selected, the text or communications will escalate with the receiver of the message. The escalation procedure is setup off the main screen by selecting settings. In an embodiment, some of these settings are the number of times the alert beep will sound for the receiver of the communication, how many times the alert will sound for the receiver, and at what interval the alert will sound for the receiver. In other embodiments, the alert may be visual such as an alert light or vibration of the device. In the bottom portion of this screen are controls for typing and sending communications.

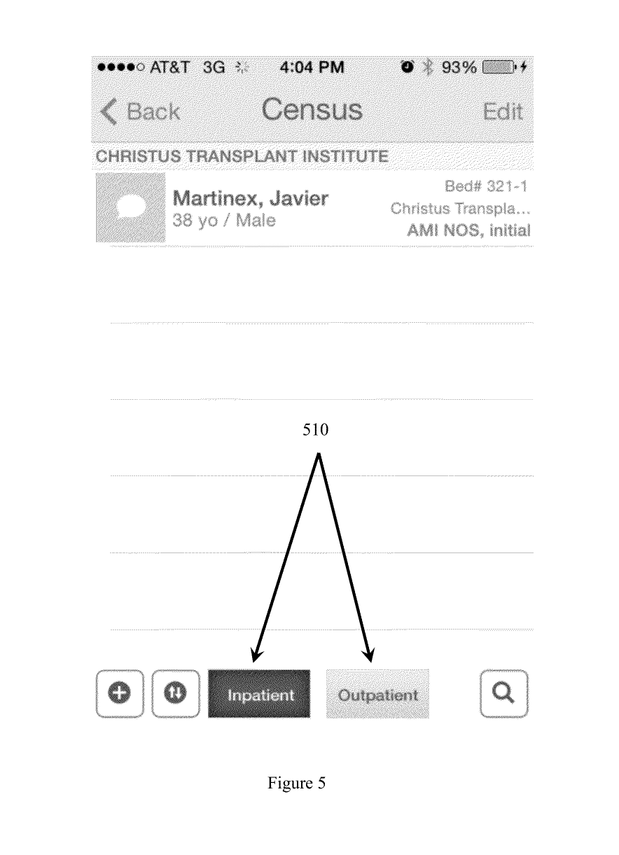

Reference is now made to FIG. 5, a census screen of the graphical user interface for the client I/O devices 150 for the health care communications management system in accordance with embodiments of the disclosure. Illustrated here is the census for a medical facility with icons to select the inpatient and outpatient list of patients 510. The magnifier glass icon allows the searching of patients, the addition icon allows the adding of patients, and the up and down arrow icon allows the sorting of the patient list.

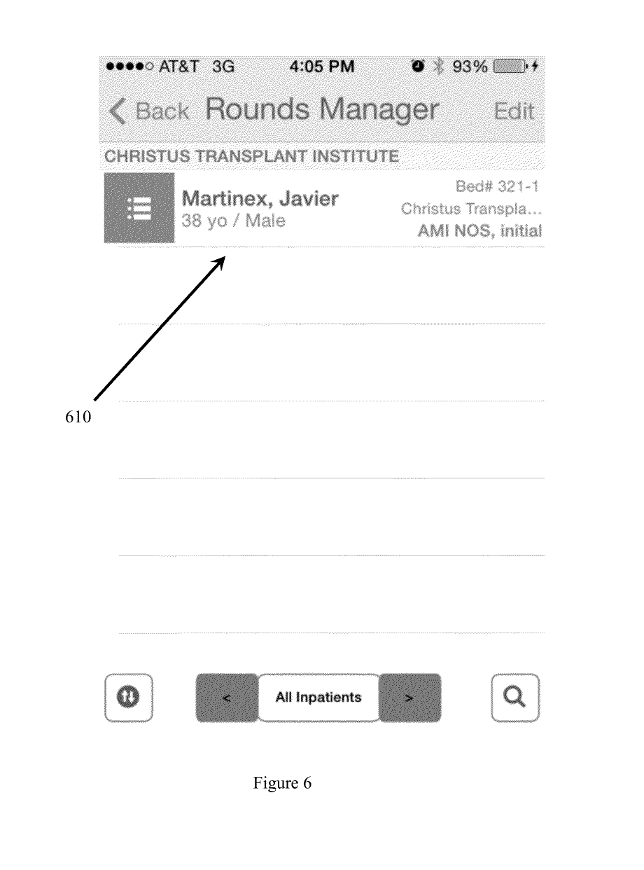

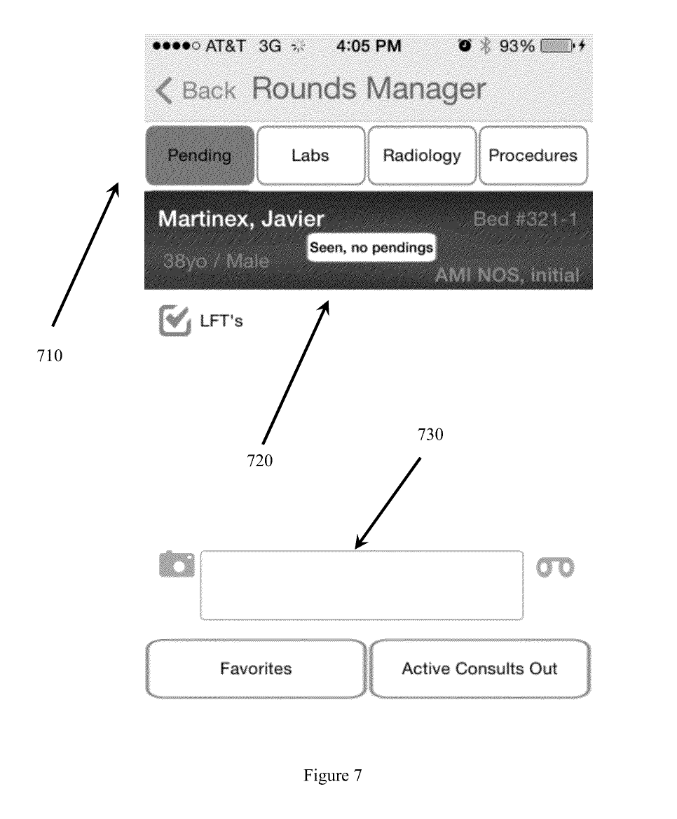

Reference is next made to FIG. 6, an initial patient selection screen for the graphical user interface for the client I/O devices 150 for the health care communications management system in accordance with embodiments of the disclosure. Illustrated in this figure is the patient list and from this screen the user can toggle between patient views such as but not limited to inpatient, outpatient, on call coverage, my inpatients, and my outpatients with the bottom icons. The system allows for healthcare providers and support staff (individuals and/or groups) to be added and subtracted before the patient receives medical care, as the patient receives medical care, and after the patient receives medical care. Patient data and communications are shared with healthcare providers and support staff (individuals and/or groups). This allows for a very flexible, efficient, and effective patient management system. In addition, the user can select which patient to work with 610. Once a patient is selected the next screen is presented as captured in FIG. 7.

Reference is now made to FIG. 7, a patient information screen for the graphical user interface for the client I/O devices 150 for the health care communications management system in accordance with embodiments of the disclosure. In this figure the detailed information for the patient is presented. The main areas are pending, labs, radiology, and procedures 710. Once one of these icons is selected, the bottom portion of the screen will present that areas information. In this illustration, the pending icon has been selected. The patient information such but not limited to name, age, sex, bed number, diagnosis code, PCP, medical group, and hospital are presented 720. The middle portion of the screen will contain that areas information. For this pending selection, all pending items from the other areas (labs, radiology, and procedures) are listed. The bottom portion of the screen allows the user to use a camera icon for attaching images, a text box for recording notes, and a tape icon for recording audio messages.

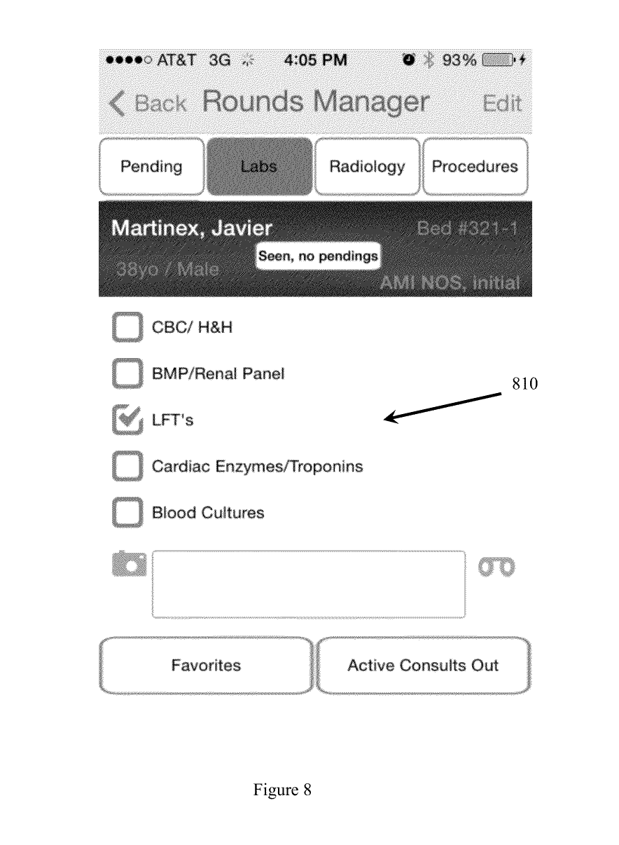

Reference is next made to FIG. 8, an additional patient information screen for the graphical user interface for the client I/O devices 150 for the health care communications management system in accordance with embodiments of the disclosure. In this figure, the labs icon has been selected. The middle portion of the screen has been updated with the labs being conducted on the patient 810. This same process is followed when the radiology and procedures icon are selected. In the labs, radiology, and procedures middle portion area, which lists the items being completed and completed, alerts can be setup for follow-up and reminders. All those in the group setup for the patient or other groups defined such as medical groups or facility groups can also be notified.

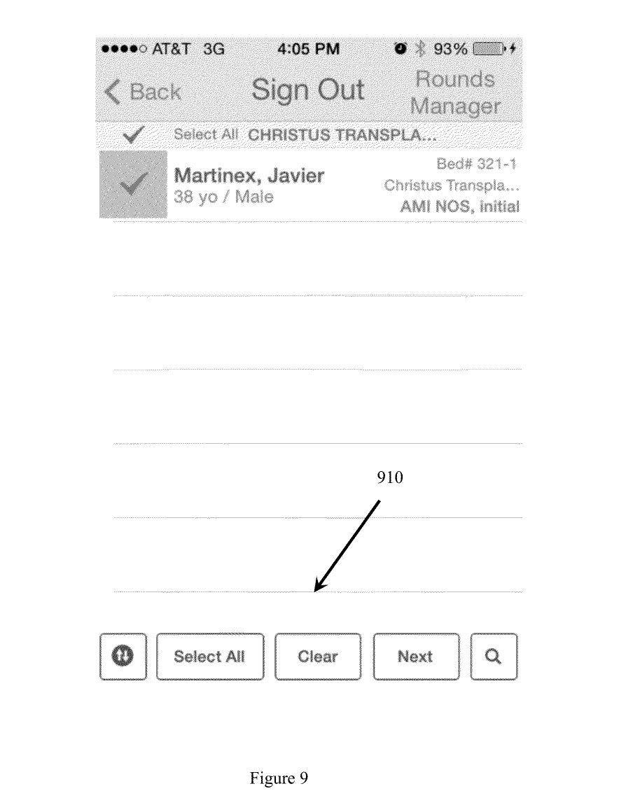

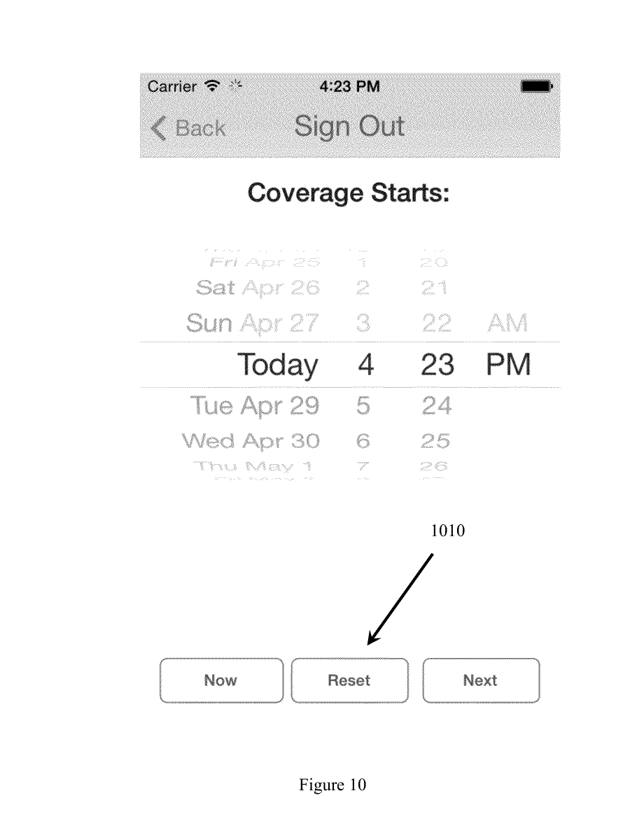

Reference is now made to FIG. 9, an initial sign out screen for the graphical user interface for the client I/O devices 150 for the health care communications management system in accordance with embodiments of the disclosure. This portion of the system allows the management and temporary coverage by on-call physicians. That is, during the coverage period the covering physician will be made part of the patient care group and will receive all communications and patient data as if he was the original physician. The middle portion of the screen lists the patients assigned to the healthcare provider and in this embodiment, the physician. This screen allows the patients to be selected for coverage by another physician. Illustrated in this figure is the only patient listed being selected. This is indicated by the large check box being selected left of the patient's information. The bottom portion of the screen is configured to provide the controls 910 for selecting the patient. Options such as select all patients, clear all selections, and next patient screen list are provided. Once the patient is selected, the physician is selected for coverage, whereupon the screen in FIG. 10 is presented to the user.

Reference is next made to FIG. 10, a coverage screen for the graphical user interface for the client I/O devices 150 for the health care communications management system in accordance with embodiments of the disclosure. Now that the patients and coverage physician has been selected, the user physician will designated the coverage period by designating the coverage starts time and the coverage ends time. The user of the system is presented with controls 1010 such as designating a time as now, resetting the time, and going to the next screen or step. In this illustration, the next step would be going to the screen presenting the user with the screen for designating the coverage ends time.

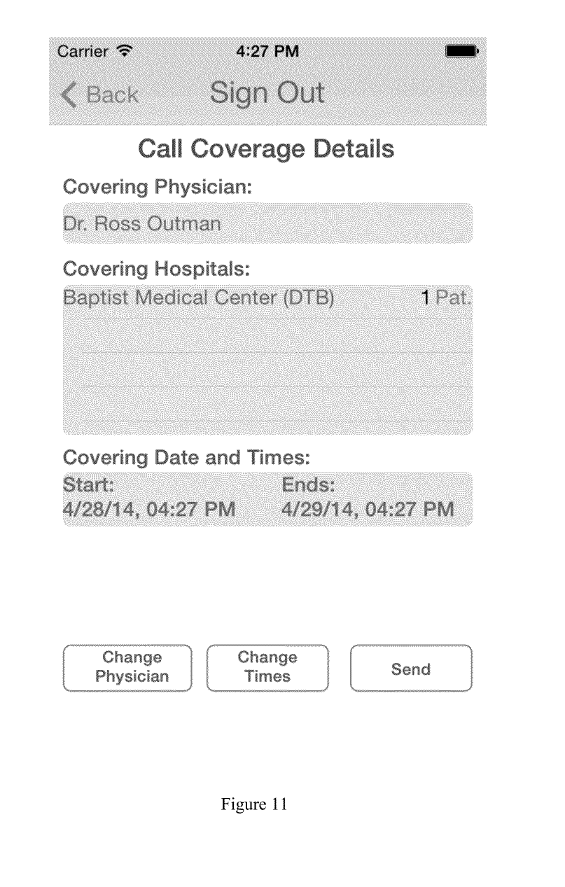

Reference is now made to FIG. 11, a sign out coverage screen summary for the graphical user interface for the client I/O devices 150 for the health care communications management system in accordance with embodiments of the disclosure. Illustrated in this figure is a display of the information for call coverage that has been setup. The covering physician, covering hospital, and coverage date and times are displayed for visual confirmation. On the bottom portion of the screen are controls for changing the physician and times for call coverage. Once the information is verified as accurate, the user or physician will select the send icon whereupon the receiving covering physician will have to accept the coverage request. Once accepted, the sending user or physician will be notified of the acceptance and the coverage information status will reflect acceptance as well.

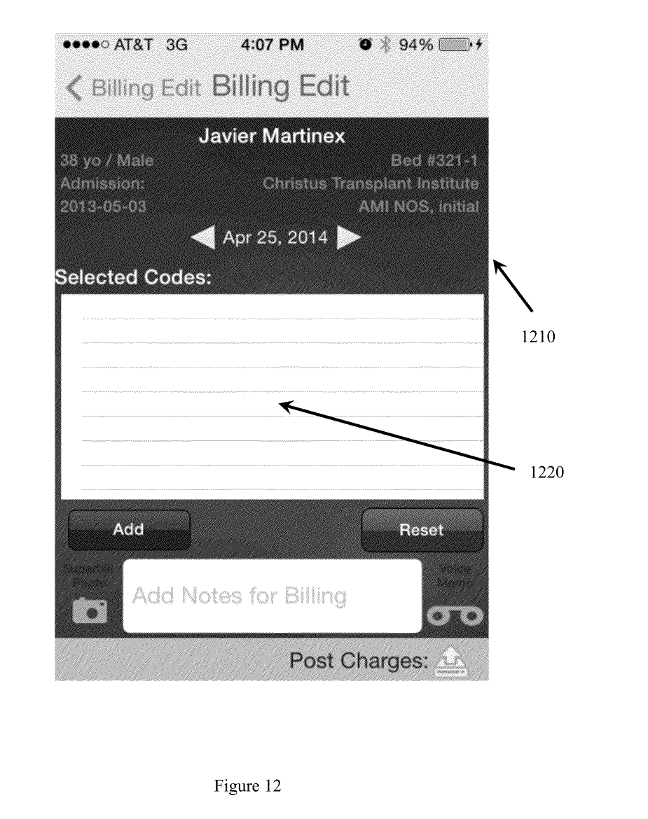

Reference is next made to FIG. 12, a billing screen of the graphical user interface for the client I/O devices 150 for the health care communications management system in accordance with embodiments of the disclosure. If the billing icon is selected from the main screen, the user is taken to the screen captured in FIG. 12. The top portion of the screen displays the date and patient information 1210. The middle portion of the screen 1220 allows the user of the system or physician to enter the billing codes. Bill entering controls such as add and reset are provided. At the bottom of the screen is a control icon for a super bill photo and an icon to add a voice memo. In addition, there is a text box to add notes for billing. Once the information is ready to be sent for processing, the post charges icon is selected which is located in the bottom right of the screen. Once the charges are sent, the billing staff is able to view and process the billing information via the billing portal. In another embodiment, the physician prepopulates the middle portion of the screen 1220 with billing codes from the last visit with the patient by selecting a prepopulate action icon. This is also referred to as one-click billing.

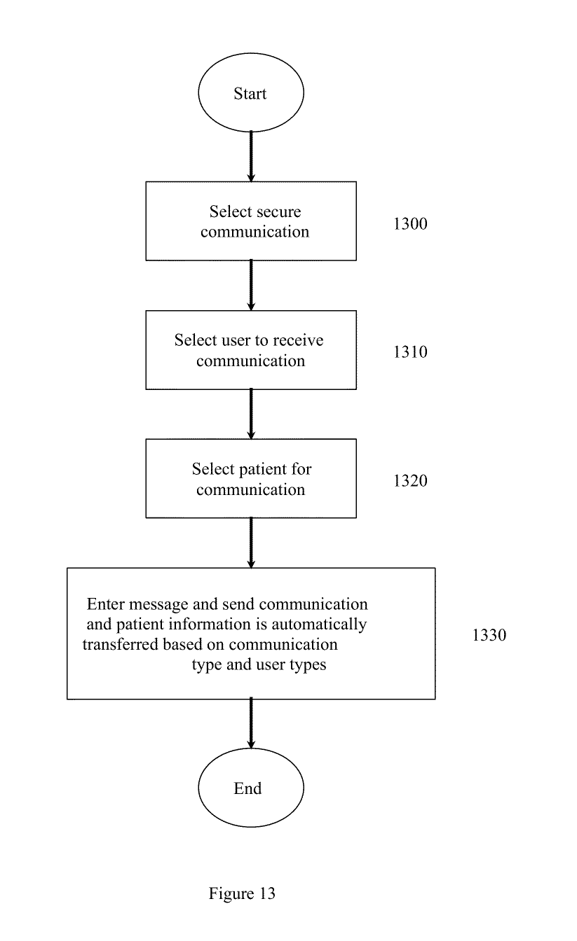

Reference is now made to FIG. 13, a work flow diagram of automatic data sharing functionality within the health care communications management system in accordance with embodiments of the disclosure. In this illustration, the structure and process is shown for automatic data sharing occurring with a communication. A logged in user will select the secure communication 1300 option. This is just the label as all communications within the system are encrypted communications. Next, the user will select the user to receive the communication 1310. The receiving user may be in any of the user group types added to the system. Next, a patient is associated with the communication 1320. Lastly, the message is entered and sent with the system automatically transferring the patient's data with the communication based on the user types and the communication type 1330. For example in a physician to physician communication, patient information such as medical care facility, bed number, sex, and diagnosis is transferred. If the patient was not already in the active patient list or census for the receiving physician, that patient can be added automatically to the physician census and he is granted access privileges to discrete elements of this patient on the database along with the patient's information, should the receiving physician desire to do so. That is, the patient and their information is added automatically to the receiving physician's database. By adding to the database we mean the local copy of the information stored on the I/O interfaces 150 and access granted on the central database server 100 to the information.

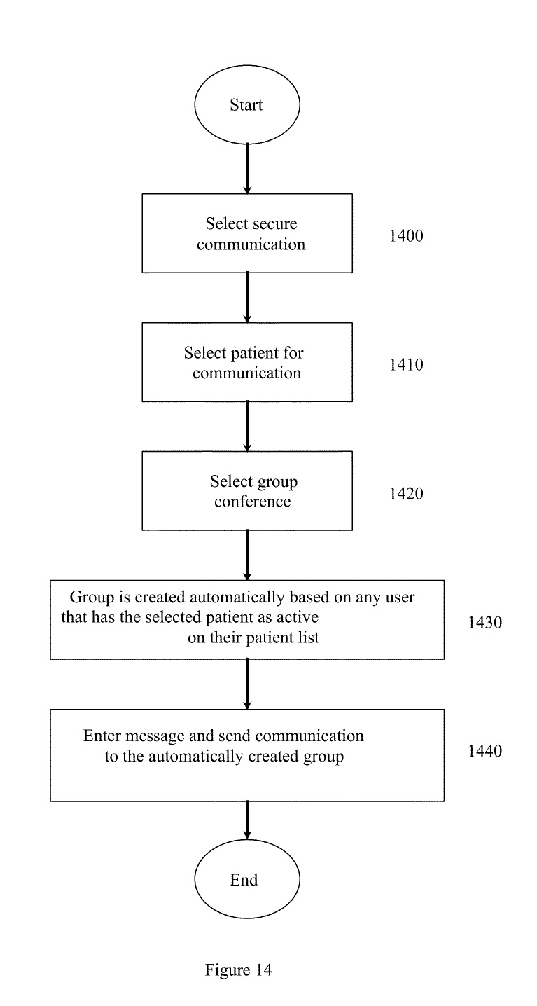

Reference is next made to FIG. 14, a work flow diagram of the automatic group messaging functionality within the health care communications management system in accordance with embodiments of the disclosure. In this illustration, the one click group messaging functionality is outlined. A logged in user selects the secure communication 1400 option. Next, the user will select the patient for which the group is to be created for 1410. The user will then select group conference 1420, whereby the system automatically creates the communications group based on any user that has the selected patient as active on their patient list 1430. The last step is to enter the message and send the communication to the group 1440. The communication will automatically get sent to all users in the group with the automatic data sharing being completed as well. This alleviates the issue of having to manually enter individual users in the creation of a group and possibly missing a user.

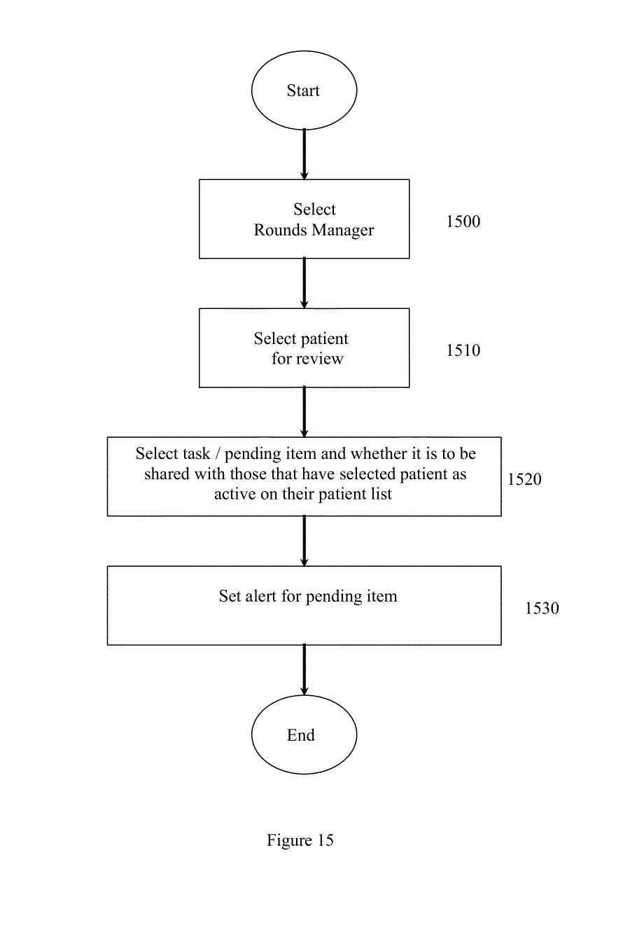

Reference is now made to FIG. 15, a work flow diagram of the automatic sharing of pending items and alerts within the health care communications management system in accordance with embodiments of the disclosure. The system is able to store individual task managers for each user. This is a component of the system which stores task lists or “to do” items and alerts or reminders on those items. Those task items are associated with individual patients. For example, a physician can set blood work to be performed on a patient with an alert or reminder set at eight hours. The alerts or reminders may be comprised of audible, visual, and/or physical means of alerting or reminding. For example, a visual change in color of the item on the screen or a pop up box with text reminding of the item may be employed to alert or remind the physician of an important event or even a vibration of the device 150 could also be employed to serve as an alert or reminder. FIG. 15 outlines the steps in setting up a task with an alert or reminder. The user will select the round manager menu item within the software 1500 and then select the patient to associate the task item or “to do” item 1510. The system can be preset with items that the user can select from or a new entry can be made 1520. Next, an alert or reminder can be set for the task or “to do” item 1530. When a physician is signing out or transferring a patient, the pending items or “to do” list will automatically be transferred to the physician taking over the patient within the system. In addition, the pending items or “to do” list can be selected to be shared so that all users that have the patient as active on their census will be able to see the pending items or “to do” list.

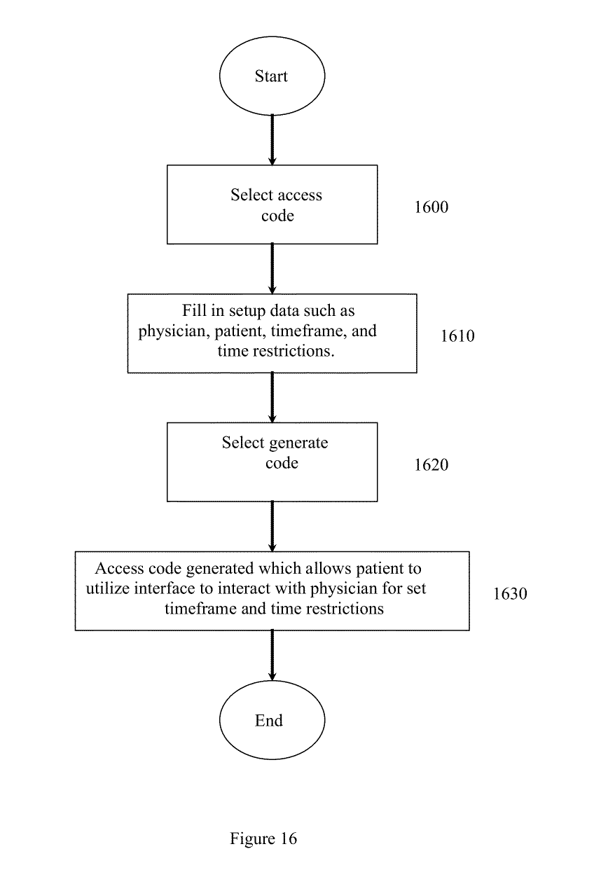

Reference is next made to FIG. 16, a work flow diagram of the post medical care communications between patients and health care providers within the health care communications management system in accordance with embodiments of the disclosure. This component allows a patient post medical care to send communications directly to a physician via an interface such as a web portal. Outlined in this diagram is the access setup process for a patient. A user with privileges to setup will select access code 1600 and then fill in the setup information such as physician, patient, timeframe or duration the patient will be allowed to generate communications with the physician, and time restrictions for generating communications 1610. Once this information is filled out, the user will select generate code 1620. The last step is performed by the system and is the generation of the actual code which allows the patient being setup to utilize the system interface to generate direct communications to the physician 1630.

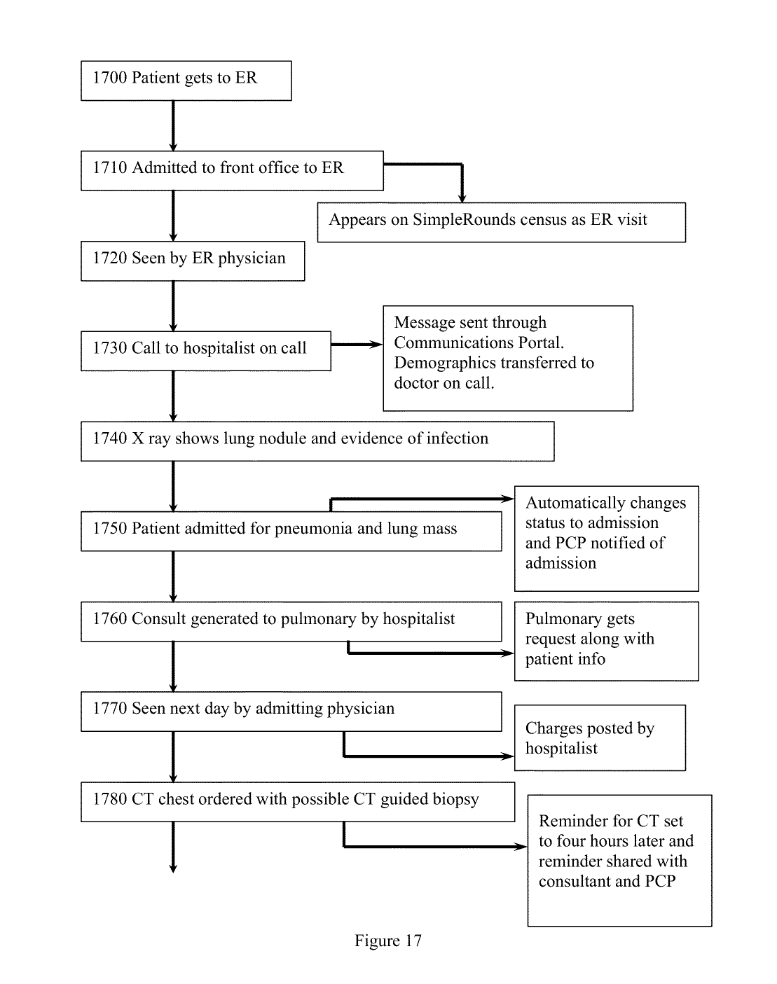

Reference is now made to FIG. 17, the first half of a work flow diagram of an ER patient admission example for the health care communications management system in accordance with embodiments of the disclosure. In this illustration is shown how the system works together and follows the patient through the medical care process. As a patient is admitted 1710 they first appear in the system's census. Those health care providers and support staff are able to pick up on the patient as they become part of the group caring for the patient. Messages from support staff can be sent through the communications portal 196 to caring physicians, nurses, and LVNs as an example 1730. That is the communications portal 196 and the billing portal 194 allow communications with the healthcare providers and support staff utilizing the main software module 192. For example, when billing codes are sent for a patient to be processed, if there is a code that looks erroneously entered the billing support staff can relay communications via the billing portal 194 to clarify with the physician. The patient information is automatically populated for the group. When a patient is admitted, the status is changed and additional members are added to the patient care group 1750, 1760. The system is driven by the patient and groups formed based on those administering care and support of the patient. Next a CT chest is ordered and would appear in the pending and radiology icon selections 710 as a pending item and setup with a reminder for four hours as a follow-up. Those in the group (consultant and PCP) would all see the CT chest order and receive the follow-up alert.

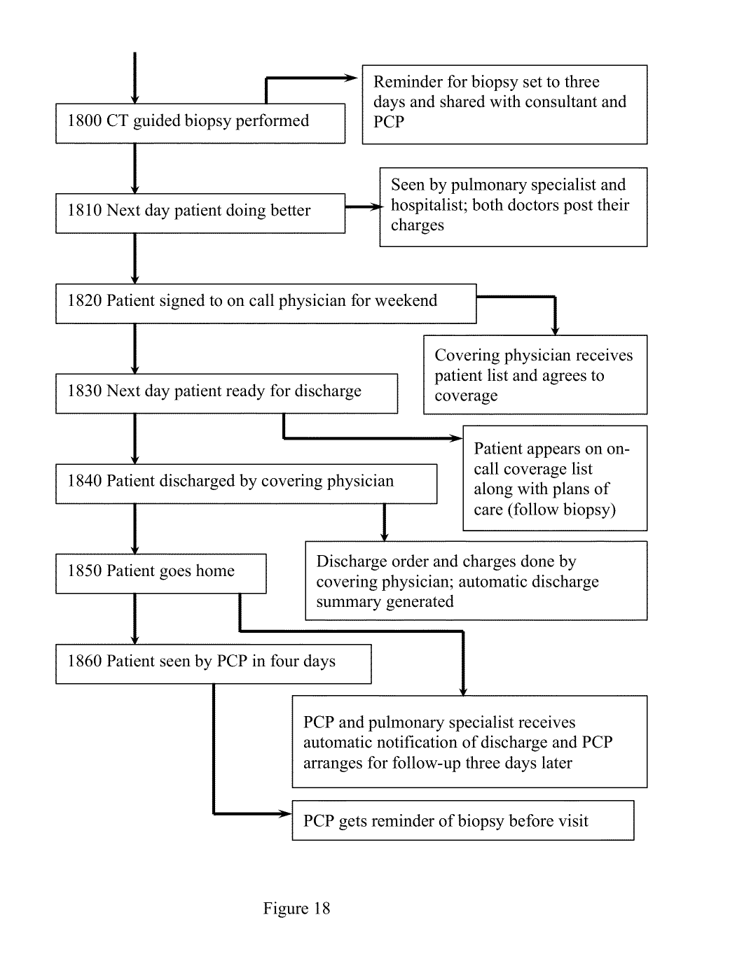

Reference is lastly made to FIG. 18, the second half of a work flow diagram of an ER patient admission example for the health care communications management system in accordance with embodiments of the disclosure. Continuing with the example, the biopsy is performed and is seen by the pulmonary specialist and hospitalist. As items are being completed, the health care support staff is able to post their charges via the billing icon selected from the main screen 192. Next, a covering physician receives the patient list and agrees to coverage, which is handled by the sign out screens as depicted in FIGS. 9-11. FIGS. 17 and 18 depict the range of options covered by the automatic sharing of communications and patient data with healthcare providers and support staff before, during, and after patient care.

In brief, as described herein provides for an effective and efficient system for managing communications between health care providers and patients before, during, and after receiving medical care.

The disclosed system and method of use is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention.

Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims.

Alternative applications for this invention include using the system and method of use for managing communications and patient data in various environments and conditions besides health care. For example, the system may be employed in law enforcement environments or military environments where communications and data are to be managed. Consequently, any embodiments comprising a one component or a multi-component system having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific device and method of use described herein. Such equivalents are considered to be within the scope of this invention and are covered by the claims.

All publications and patent applications mentioned in the specification are indicative of the level of those skilled in the art to which this invention pertains. All publications and patent application are herein incorporated by reference to the same extent as if each individual publication or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The system and/or methods disclosed and claimed herein can be made and executed without undue experimentation in light of the present disclosure. While the system and methods of this invention have been described in terms of preferred embodiments, it will be apparent to those skilled in the art that variations may be applied to the system and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A system for managing health care communications and patient care data comprising:
a central database server comprising
one or more processors;
a non-transitory computer-readable storage medium;
a transitory computer-readable storage medium;
a client input/output graphical user interface device communicatively coupled to said central database server and said client input/output graphical user interface device configured for sending and receiving communications and patient data between health care providers and support staff;
said central database server configured to manage shared and non shared communications and patient data between health care providers and support staff based on communication and patient data logic.

2. The system of claim 1, wherein said graphical user interface device is a workstation;

3. The system of claim 1, wherein said graphical user interface device is a laptop;

4. The system of claim 1, wherein said graphical user interface device is a mobile device;

5. The system of claim 1, wherein said central database server is further configured to manage shared and non shared communications and patient data between health care providers and support staff based on groups.

6. The system of claim 1, wherein said central database server is further configured to manage shared and non shared communications and patient data between health care providers and support staff based on physician groups.

7. The system of claim 1, wherein said central database server is further configured to manage shared and non shared communications and patient data between health care providers and support staff based on medical groups.

8. The system of claim 1, wherein said central database server is further configured to manage shared and non shared communications and patient data between health care providers and support staff based on patients.

9. The system of claim 1, wherein said central database server is further configured to manage shared and non shared communications and patient data between health care providers and support staff based on physician groups, medical groups, and patients.

10. The system of claim 1, wherein said shared communications and patient data is automatic.

11. The system of claim 1, wherein said shared data is comprised of diagnostic codes.

12. The system of claim 1, wherein said shared data is comprised of diagnostic codes ordered by most commonly used.

13. The system of claim 1, wherein said shared data is comprised of system users presented by physician groups, medical groups, and patients.

14. The system of claim 1, wherein said shared and non-shared communications and patient data is comprised of text messaging.

15. The system of claim 1, wherein said shared and non-shared communications and patient data can be permanently or temporarily transferred to another healthcare provider or support staff.

16. The system of claim 15, wherein said system confirms the acceptance or non-acceptance of the transfer by the receiving healthcare provider or support staff and updates the status with the transferring healthcare provider or support staff.

17. The system of claim 14, wherein said text messaging is also comprised of one click group messaging.

18. The system of claim 17, wherein said group messaging is based on physician groups, medical groups, or patient groups.

19. The system of claim 14, wherein said text messaging escalates on preset time intervals with the sender and receiver. (with the acuity of the event)

20. A system for managing health care communications and patient care data comprising:
a central database server comprising
one or more processors;
a non-transitory computer-readable storage medium;
a transitory computer-readable storage medium;
a client input/output graphical user interface device communicatively coupled to said central database server and said client input/output graphical user interface device configured for sending and receiving communications and patient data between health care providers and support staff;
said central database server further configured to manage shared and non shared communications and patient data between health care providers and support staff based on communications and patient data logic comprising groups;
said shared communications and patient data is automatic;
said shared and non-shared communications and patient data is comprised of text messaging;
said shared and non-shared communications and patient data can be permanently or temporarily transferred to another healthcare provider or support staff;
said text messaging is also comprised of one click group messaging;
said group messaging is based on physician groups, medical groups, or patient groups;
and said text messaging escalates on preset time intervals with the sender and receiver.

21. A method for sending a shared communication through a system for managing health care communications and patient care data comprising the steps of:
selecting the communication option;
selecting the users to receive the communication;
selecting the patient for the communication;
entering and sending the communication with the patient information automatically transferred with the communication by the system based on communication type and user type.

22. A method for sending a shared group communication through a system for managing health care communications and patient care data comprising the steps of:
selecting the communication option;
selecting the patient for the communication;
selecting the group communications option;
the system automatically creating a user receiving group based on any user that has selected patient as active on their patient list;
entering and sending the communication with the patient information automatically transferred with the communication by the system based on communication type and user type.

23. A method for setting up access codes through a system for managing health care communications and patient care data comprising the steps of:
selecting the access code option;
entering setup data for access code;
selecting the generate code option;
the system automatically generating an access code which allows the patient to utilize an interface to interact with physicians for established setup data.
